(19) United States
(12) Patent Application Publication
(10) Pub. No.: US 2013/0179839 A1
(43) Pub. Date: Jul. 11, 2013

(54) CONTENTS REPRODUCING DEVICE, CONTENTS REPRODUCING METHOD

(71) Applicant: Fujitsu Limited, Kawasaki-shi (JP)

(72) Inventors: Yasufumi NAKAMURA, Kawasaki (JP); Kazuya Fujikawa, Kawasaki (JP); Yuki Wakayama, Kawasaki (JP); Kazuhiro Koyata, Kawasaki (JP); Aki Kita, Kawasaki (JP)

(21) Appl. No.: 13/670,598

(22) Filed: Nov. 7, 2012

(30) Foreign Application Priority Data
Jan. 5, 2012 (JP) 2012-000746

(51) Int. Cl. G06F 17/30; G06F 3/0482

(52) U.S. Cl. CPC G06F 17/30002; G06F 3/0482
USPC 715/830; 707/609

(57) ABSTRACT

A contents reproducing device is connected to a reproduction unit that reproduces contents data. The contents reproducing device includes a storage unit configured to store the contents data; an extraction unit configured to extract condition-satisfying-contents data that satisfies a predetermined extraction condition from the contents data stored in the storage unit, and store information identifying the extracted condition-satisfying-contents data in the storage unit; a reproduction control unit configured to cause the reproduction unit to reproduce the contents data in the storage unit in units of the condition-satisfying-contents data; and a report control unit configured to determine whether non-reproduced condition-satisfying-contents data that has not been reproduced by the reproduction control unit is present, and to cause a report unit to make a report relevant to the non-reproduced condition-satisfying-contents data when the non-reproduced condition-satisfying-contents data is present.

### CROSS-REFERENCE TO RELATED APPLICATION

This patent application is based upon and claims the benefit of priority of the prior Japanese Patent Application No. 2012-000746 filed on Jan. 5, 2012, the entire contents of which are incorporated herein by reference.

### FIELD

The embodiments discussed herein are related to a contents reproducing device and a contents reproducing method.

### BACKGROUND

Conventionally, there is known a contents reproducing device for extracting, from contents data to which date information is attached, one or more contents data items based on a temporal standard determined in advance, and reproducing the extracted one or more contents data items (see, for example, patent document 1). In this device, the display screen is divided, and data items of a particular date over plural years or data items of a particular year are specified among contents stored in a database, and the specified data items are displayed as a slideshow in one part of the divided screen.

Patent Document 1: Japanese Laid-Open Patent Publication No. 2009-271224

However, in the above conventional device, the contents are reproduced when a user selects, through an operation panel, the target “memory frame” from a menu including selection items corresponding to executable functions displayed on a display screen of an LCD. That is to say, the contents are reproduced depending on spontaneous operations by the user, and therefore it is not possible to actively provide opportunities of reproducing contents to the user.

### SUMMARY

According to an aspect of the embodiments, a contents reproducing device connected to a reproduction unit that reproduces contents data includes a storage unit configured to store the contents data; an extraction unit configured to extract condition-satisfying-contents data that satisfies a predetermined extraction condition from the contents data stored in the storage unit, and store information identifying the extracted condition-satisfying-contents data in the storage unit; a reproduction control unit configured to cause the reproduction unit to reproduce the contents data in the storage unit in units of the condition-satisfying-contents data; and a report control unit configured to determine whether non-reproduced condition-satisfying-contents data that has not been reproduced by the reproduction control unit is present, and to cause a report unit to make a report relevant to the non-reproduced condition-satisfying-contents data when the non-reproduced condition-satisfying-contents data is present.

The object and advantages of the invention will be realized and attained by means of the elements and combinations particularly pointed out in the appended claims. It is to be understood that both the foregoing general description and the following detailed description are exemplary and explanatory and are not restrictive of the invention as claimed.

### BRIEF DESCRIPTION OF THE DRAWINGS

FIG. 1 illustrates a hardware configuration of a contents reproducing device according to an embodiment of the present invention;

FIG. 2 illustrates a logical configuration of the contents reproducing device;

FIG. 3 is a flowchart that simply illustrates the overall flow of a process executed by the contents reproducing device according to the present embodiment;

FIG. 4 illustrates data stored as an image database;

FIG. 5 illustrates an example of data stored as a reproduction list;

FIG. 6 illustrates two examples of XML files specifying extraction conditions and presentation periods of the respective reproduction list names;

FIG. 7 is a flowchart illustrating the flow of a process performed when the reproduction list is newly created or updated;

FIG. 8 is a flowchart illustrating the flow of a process executed by a report control unit;

FIG. 9 illustrates tickets displayed on a desktop screen of a monitor;

FIG. 10 illustrates tickets displayed on a desktop screen of a monitor;

FIG. 11 is a flowchart illustrating the flow of a ticket image update process executed by the report control unit;

FIG. 12 is a flowchart illustrating the flow of a process executed by a reproduction list selection receiving unit;

FIG. 13 illustrates an example of display layout information;

FIG. 14 is a flowchart illustrating the flow of a process executed by an extraction process/reproduction control unit;

FIG. 15 is a flowchart of a process executed by the extraction process/reproduction control unit when the method of extracting images is “random”;

FIG. 16 is a flowchart of a process executed by the extraction process/reproduction control unit when the method of extracting images is “extract by predetermined intervals”; and

FIG. 17 is a flowchart of a process executed by the extraction process/reproduction control unit when the method of extracting images is “extract by prioritizing days with many saved images”.

### DESCRIPTION OF EMBODIMENTS

Preferred embodiments of the present invention will be explained with reference to accompanying drawings.

Embodiment

In the following, a description is given of a contents reproducing device according to an embodiment of the present invention, with reference to accompanying drawings.

Hardware configuration

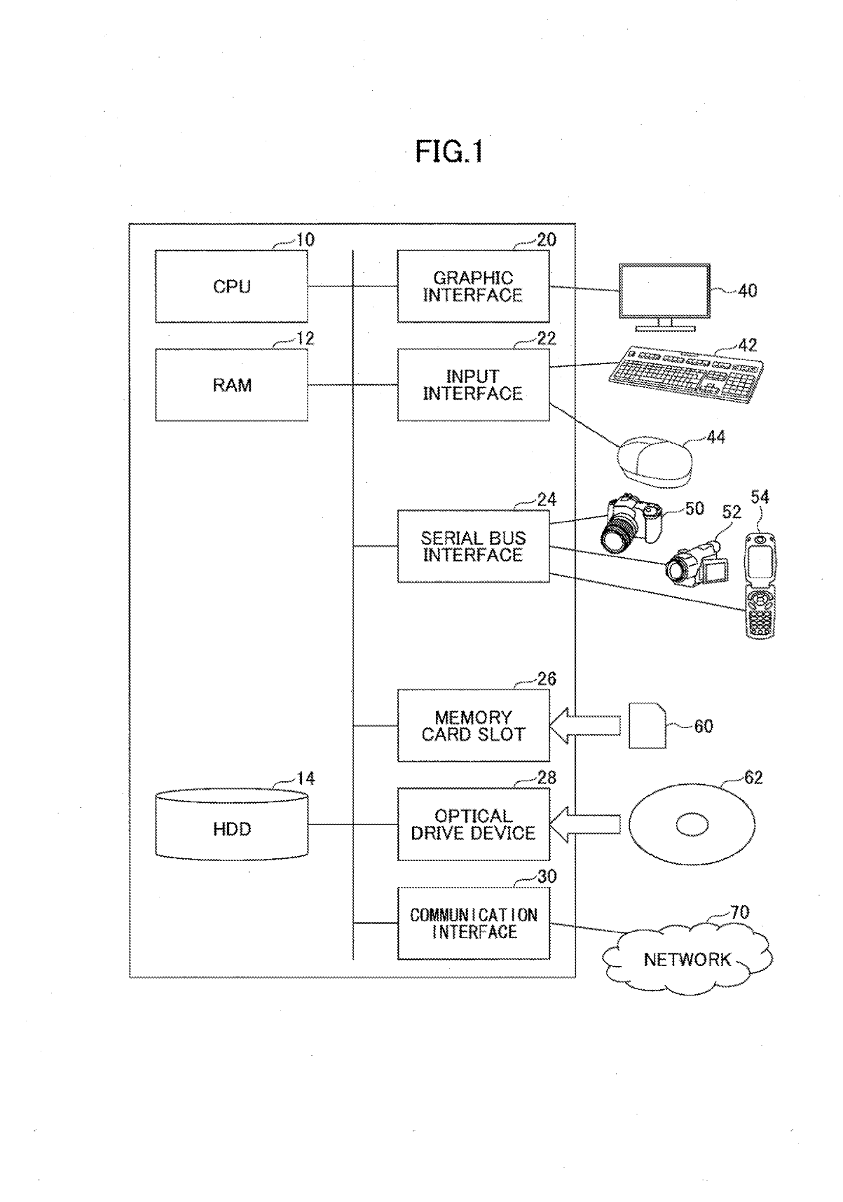

FIG. 1 illustrates a hardware configuration of a contents reproducing device 1 according to an embodiment of the present invention. The contents reproducing device 1 includes, for example, a CPU 10, a RAM 12, and a HDD (Hard Disk Drive) 14. Furthermore, the contents reproducing device 1 includes a graphic interface 20, an input interface 22, a serial bus interface 24, a memory card slot 26, an optical drive device 28, and a communication interface 30.

The above configuration is one example; the contents reproducing device 1 may include a storage device such as a flash memory, an EEPROM (Electrically Erasable and Programmable Read-Only Memory), and a ROM (Read-Only Memory). Furthermore, the contents reproducing device 1 may include a USB (Universal Serial Bus) connector for inserting a storage medium such as a USB memory.

The CPU 10 is a processor including a program counter, an instruction decoder, various computing units, a LSU (Load Store Unit), and a general-purpose register. The RAM 12 functions as a working memory, in which programs to be executed by the CPU 10 are loaded from the HDD 14, and execution results of programs are temporarily stored.

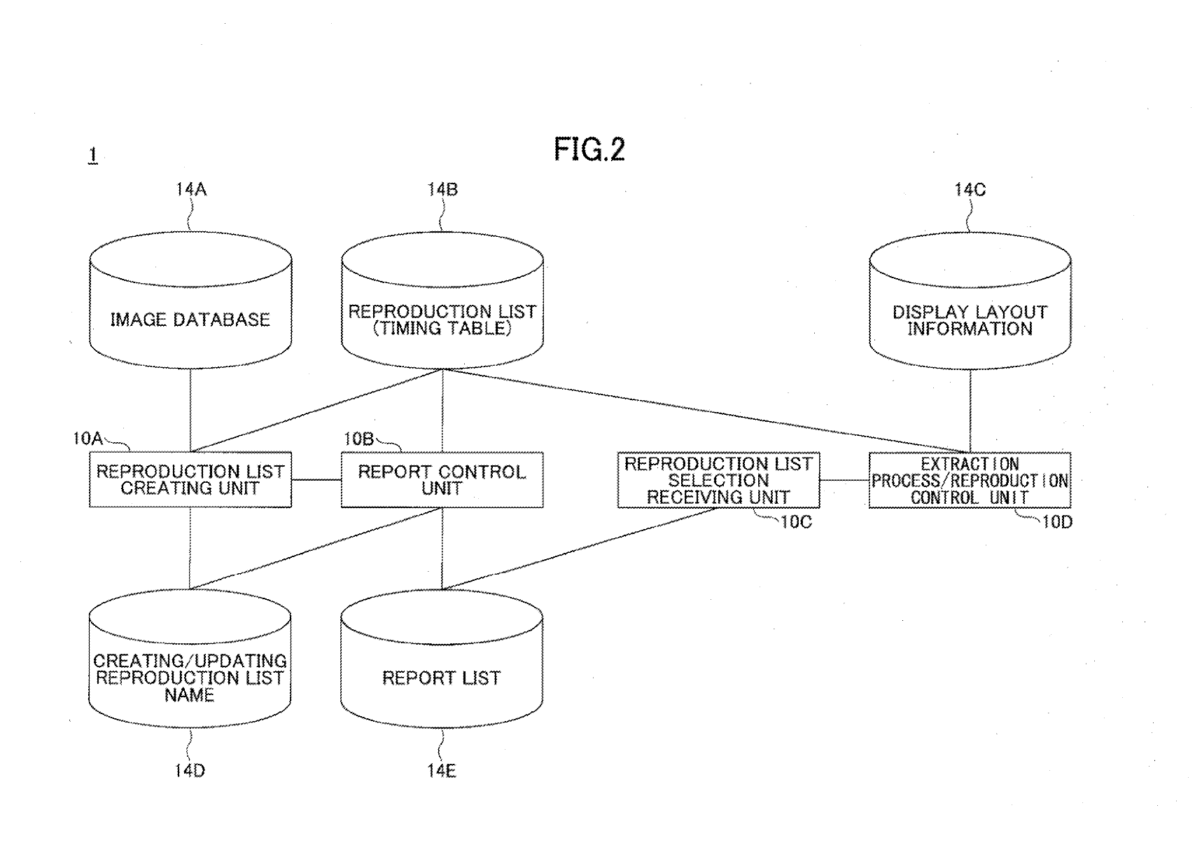

The HDD 14 stores various programs to be executed by the CPU 10, an image database 14A, a reproduction list 14B, display layout information 14C, a creating/updating reproduction list name 14D, and a report list 14E (see FIG. 2).

To the contents reproducing device 1, peripheral devices such as a monitor 40, a keyboard 42, and a mouse 44 are connected. The graphic interface 20 controls the display of the monitor 40, and the input interface 22 converts the operations input by the user to the keyboard 42 and the mouse 44 into signals, and outputs the signals to the main unit of the contents reproducing device 1.

To the contents reproducing device 1, devices such as a camera 50, a video camera 52, and a mobile phone 54 may be connected. The serial bus interface 24 controls communications with these devices that are capable of transmitting contents data.

Furthermore, to the contents reproducing device 1, a storage medium such as a memory card 60 and an optical disk 62 may be inserted. The memory card slot 26 reads contents data stored in the memory card 60 when the memory card 60 is inserted. The optical drive device 28 reads the contents data stored in the optical disk 62 when the optical disk 62 is inserted.

The communication interface 30 controls communications with other computers via a network 70. The network 70 may be the Internet, a LAN (Local Area Network), and a wireless network.

Programs executed by the CPU 10 may be acquired from a storage medium such as the memory card 60 and the optical disk 62, and may be downloaded from another computer via the network 70 by the communication interface 30. Furthermore, programs executed by the CPU 10 may be stored in a secondary storage device or a ROM of the contents reproducing device 1 in advance.

Contents data acquired by the serial bus interface 24, the memory card slot 26, the optical drive device 28, and the communication interface 30 is, for example, image data of still images and video images. In the following descriptions, it is assumed that the contents data reproduced by the contents reproducing device 1 is image data.

The image data may be taken by devices such as the camera 50, the video camera 52, and the mobile phone 54, input to the contents reproducing device 1 via the serial bus interface 24, and stored in the HDD 14. The image data may be read from the memory card 60 by the memory card slot 26 and stored in the HDD 14. The image data may be read from the optical disk 62 by the optical drive device 28, and stored in the HDD 14. The image data may be acquired from another computer by the communication interface 30 via the network 70, and stored in the HDD 14.

In the following description, it is assumed that the image data has been taken by some device.

Logical configuration

FIG. 2 illustrates a logical configuration of the contents reproducing device 1. The contents reproducing device 1 includes, as functional blocks that function as the CPU 10 which executes programs stored in the HDD 14, a reproduction list creating unit 10A, a report control unit 10B, a reproduction list selection receiving unit 10C, and an extraction process/reproduction control unit 10D. The operations may not be implemented by programs clearly separated by these functional blocks. The operations may be called as subroutines and functions by other programs. Some of the functional blocks may be hardware units such as a LSI (Large Scale Integrated circuit), an IC (Integrated Circuit), and a FPGA (Field Programmable Gate Array).

The reproduction list creating unit 10A of the present embodiment corresponds to an “extraction unit”. The extraction process/reproduction control unit 10D of the present embodiment corresponds to a “reproduction control unit”.

These functional blocks perform processes using the image database 14A, the reproduction list 14B, the display layout information 14C, the creating/updating reproduction list name 14D, and the report list 14E stored in the HDD 14.

Overall flow

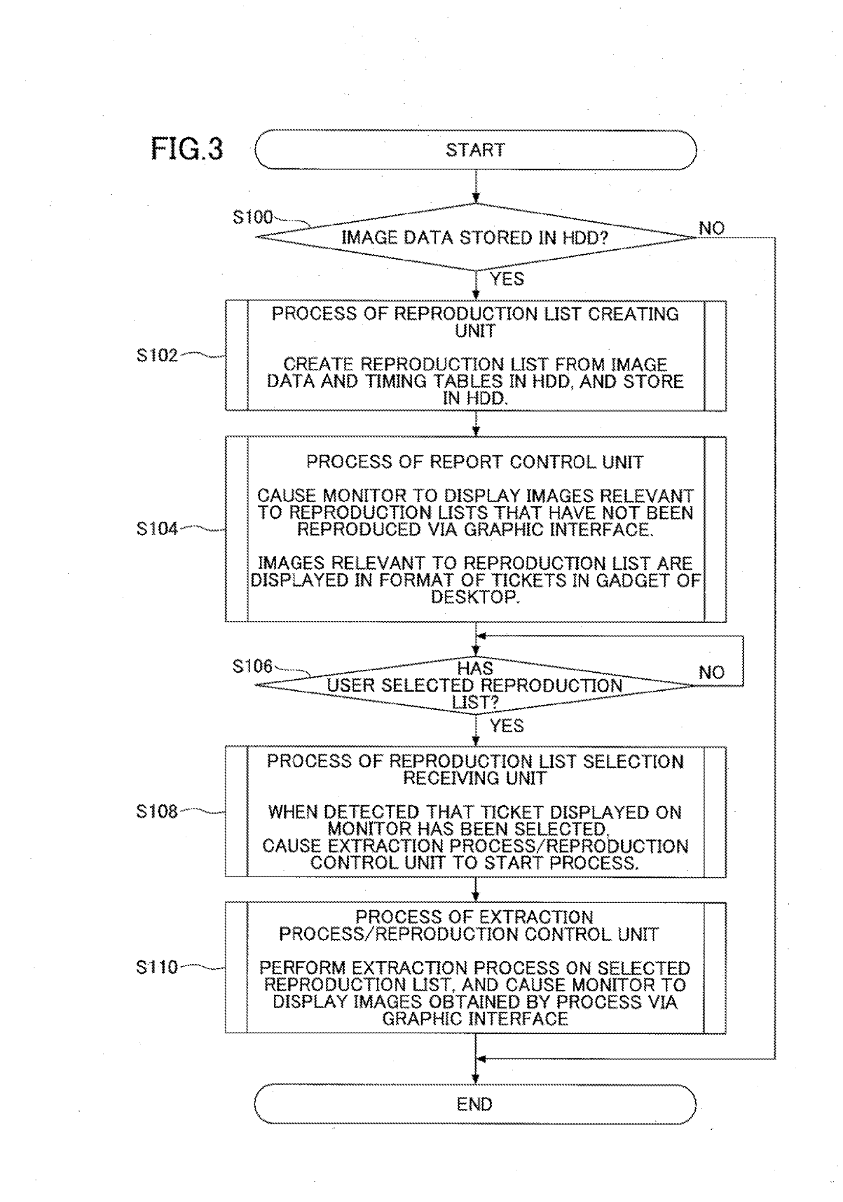

FIG. 3 is a flowchart that simply illustrates the overall flow of a process executed by the contents reproducing device 1 according to the present embodiment.

First, the contents reproducing device 1 determines whether image data has been stored in the HDD 14 (step S100).

When the image data is stored in the HDD 14, the reproduction list creating unit 10A creates a reproduction list from the image data and timing tables in the HDD 14, and stores the reproduction list in the HDD 14 (step S102).

Next, the report control unit 10B causes the monitor 40 to display images relevant to reproduction lists that have not been reproduced via the graphic interface 20 (step S104). For example, images relevant to the reproduction list are displayed in the format of tickets in a gadget of a desktop.

Next, the reproduction list selection receiving unit 10C waits for a user to select a reproduction list (step S106). When the reproduction list selection receiving unit 10C detects that a ticket displayed on the monitor 40 has been selected, the reproduction list selection receiving unit 10C causes the extraction process/reproduction control unit 10D to start a process (step S108).

Next, the extraction process/reproduction control unit 10D performs an extraction process on the selected reproduction list, and causes the monitor 40 to display the images obtained as a result of the process, via the graphic interface 20 (step S110).

Create/update reproduction list

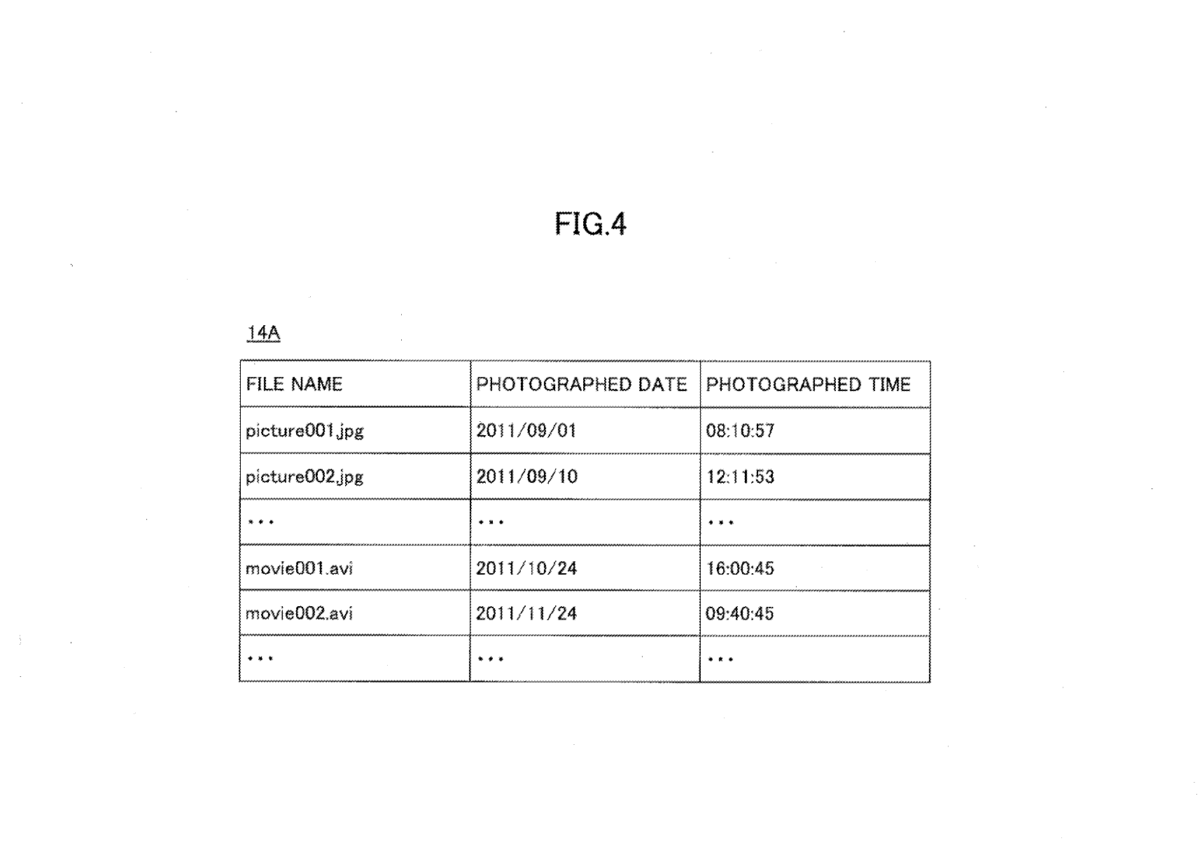

The image database 14A is an assembly of image data acquired from various routes as described above. FIG. 4 illustrates data stored as the image database 14A. As illustrated in FIG. 4, each image data item is identified by a file name, and information such as the photographed date and the photographed time is attached to the image data item. In FIG. 4, “picture” indicates a still image and “movie” indicates a video image. Furthermore, in the image database 14A, when an image is taken with a camera having a GPS (Global Positioning System) function, the photographed location (coordinates) may also be attached to the image data item.

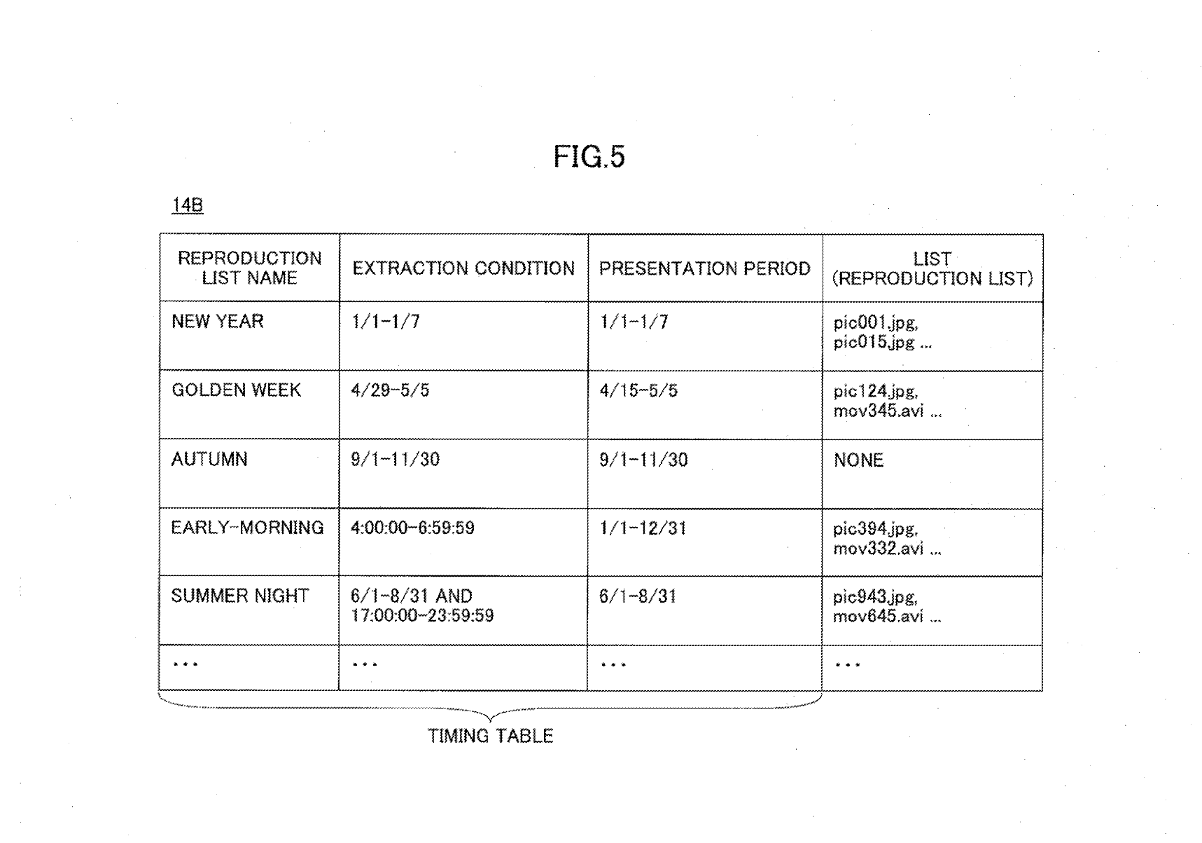

The reproduction list 14B is a data table for identifying a group of image data extracted according to a predetermined extraction condition from the image database by the reproduction list creating unit 10A. FIG. 5 illustrates an example of data stored as the reproduction list 14B. As illustrated in FIG. 5, the reproduction list 14B is data in which plural reproduction list names are associated with extraction conditions, presentation periods, and target image lists. In the following, among the contents in the reproduction list 14B, the reproduction list name, the extraction condition, and the presentation period are referred to as a “timing table” as a matter of convenience (see FIG. 5).

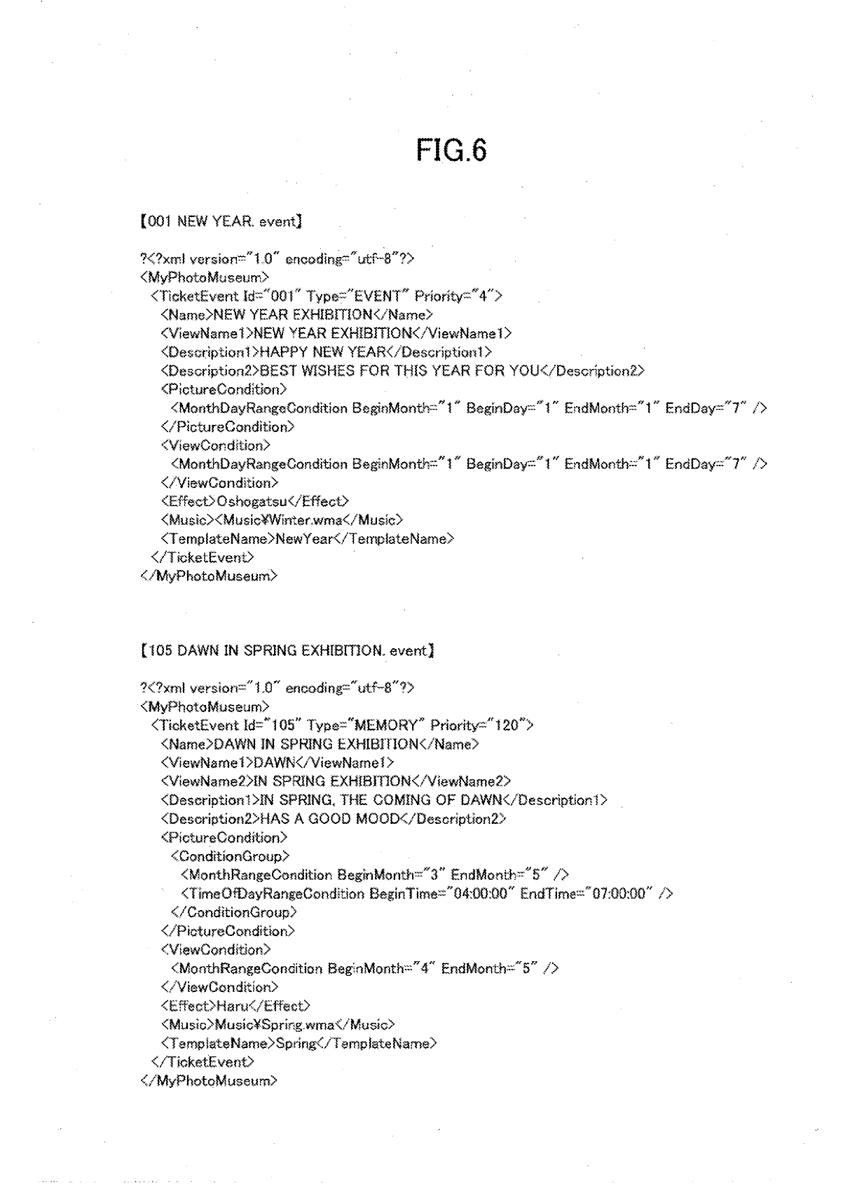

The contents specified in the timing table are defined in advance by an XML file in the initial state of the contents reproducing device 1. FIG. 6 illustrates two examples of XML files specifying extraction conditions and presentation periods of the respective reproduction list names. In each file, “Name” indicates the reproduction list name, “Picture Condition” indicates the extraction condition, and “View Condition” indicates the presentation period. The timing table is not limited to be defined by these XML files; the timing table may be stored as table data in the HDD 14.

The reproduction list name in the reproduction list 14B (timing table) is the title that is the theme of each reproduction list. The reproduction list creating unit 10A selects a file name of image data satisfying the extraction conditions in terms of the photographed date and the photographed time from the image data stored in the image database 14A, and adds the selected file name of image data to the field of target image lists in the reproduction list 14B.

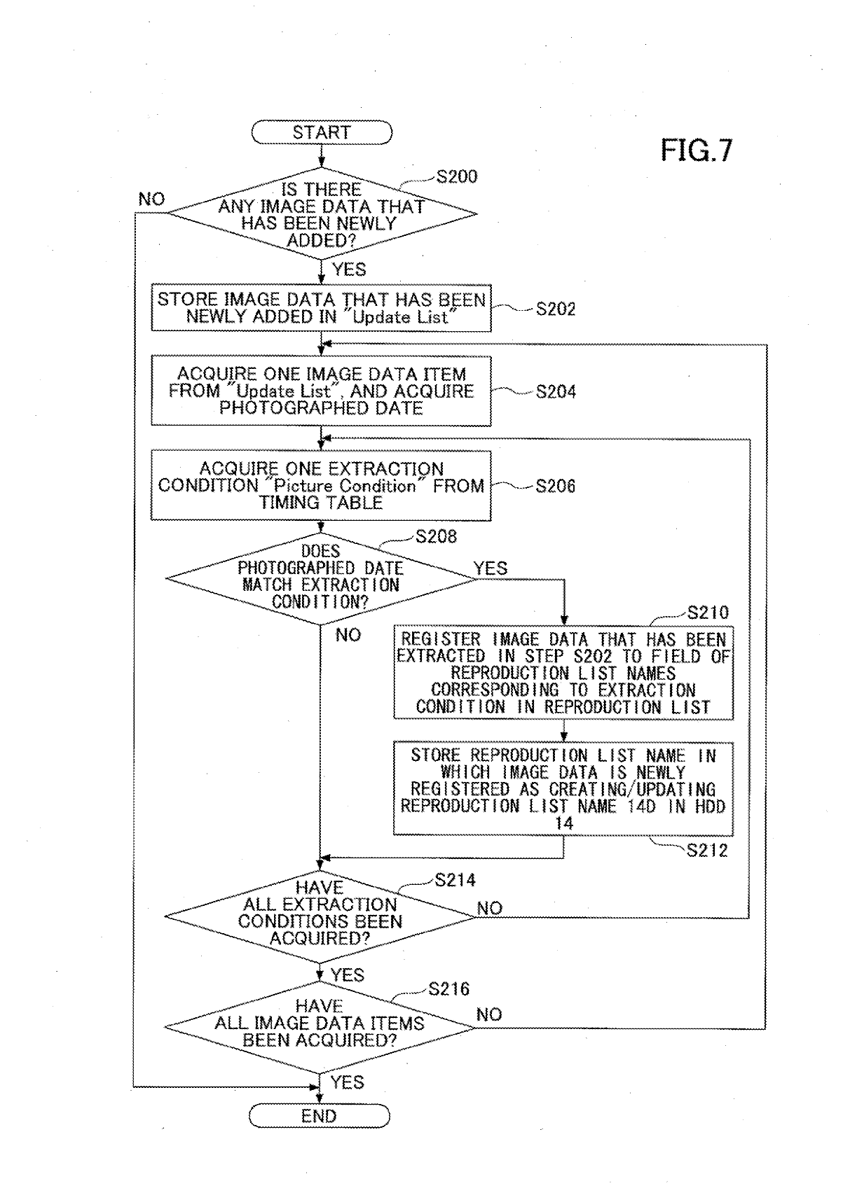

FIG. 7 is a flowchart illustrating the flow of a process performed when the reproduction list 14B is newly created or updated. For example, the process of this flowchart is executed by the reproduction list creating unit 10A when the contents reproducing device 1 is activated, when the OS is activated, and when the contents reproducing device 1 recovers from a standby state. Furthermore, the flow of the present flowchart may be periodically executed by a timer process, or may be started at the time point when it is reported from an application for storing images and videos that the images and videos have been stored.

First, the reproduction list creating unit 10A determines whether there is any image data that has been newly added to the image database 14A (step S200). When there is no image data that has been newly added to the image database 14A, the reproduction list creating unit 10A ends the process of the flowchart.

When there is image data that has been newly added to the image database 14A, the reproduction list creating unit 10A stores the image data that has been newly added to the image database 14A in the “Update List” (step S202). The “Update List” is a data area that is set in the RAM 12. For making this determination, it is assumed that information indicating whether the image data has already been processed in the flow of the present flowchart or the image data has not been processed in the flow of the present flowchart, is attached to each image data item in the image database 14A.

Next, the reproduction list creating unit 10A acquires one image data item from the “Update List”, and acquires the photographed date of the image data (step S204).

Next, the reproduction list creating unit 10A acquires one extraction condition “Picture Condition” from the timing table (step S206), and determines whether the photographed date of the image data acquired in step 5204 corresponds to the extraction condition extracted in step 5206 (step S208).

When the photographed date of the image data corresponds to the extraction condition, the reproduction list creating unit 10A registers the image data that has been extracted in step 5202 to the field of reproduction list names corresponding to the extraction condition in the reproduction list 14B (step S210). At this time, the reproduction list creating unit 10A stores the reproduction list name in which image data is newly registered as the creating/updating reproduction list name 14D in the HDD 14 (step S212). Instead of registering the reproduction list name as the creating/updating reproduction list name 14D, the reproduction list creating unit 10A may add an identifier identifying the reproduction list name in which image data is newly registered to the reproduction list 14B (the same applies to the following cases). Furthermore, the reproduction list creating unit 10A may report by software interruption to the report control unit 10B, that the creating/updating reproduction list name 14D has been updated or an identifier has been newly assigned.

Next, the reproduction list creating unit 10A determines whether all extraction conditions have been extracted from the timing table (step S214). When all extraction conditions have not been extracted from the timing table, the reproduction list creating unit 10A returns to step 5206 and acquires the next extraction condition.

When all extraction conditions have been acquired from the timing table, the reproduction list creating unit 10A determines whether all image data items have been acquired from the “Update List” (step S216). When all image data items have not been acquired from the “Update List”, the reproduction list creating unit 10A returns to step S204, and acquires the next image data.

When all image data items have been acquired from the “Update List”, the reproduction list creating unit 10A ends the process of the present flowchart.

The extraction conditions are not limited to conditions relevant to time as described above. The reproduction list creating unit 10A may set a person recognized by face image recognition as the extraction condition, and extract image data corresponding to a reproduction list name such as friends and family. In this case, the reproduction list creating unit 10A performs a matching process on the arrangement of feature points in the entire face (both edges of eyes, tip of nose, both edges of mouth) and the sizes of the parts in the face image included in the image data, and when the matching rate is greater than or equal to a threshold, the reproduction list creating unit 10A determines that the it is the same person. As for people corresponding to friends and family, face images and names used for comparison are to be registered in advance.

Report control

A description is given of a process performed by the report control unit 10B. Here, an image data group belonging to each reproduction list name in the reproduction list 14B is expressed as a “reproduction list” according to need (see FIG. 5). This reproduction list corresponds to “condition-satisfying-contents data”.

The reproduction list 14B reports, to the user, the reproduction lists that have not been reproduced by the extraction process/reproduction control unit 10D and that correspond to the presentation period in the timing table, among the reproduction lists corresponding to the reproduction list names registered in the creating/updating reproduction list name 14D. The presentation period “View Condition” in the reproduction list 14B (timing table) defines the period that the reproduction list 14B performs the reporting.

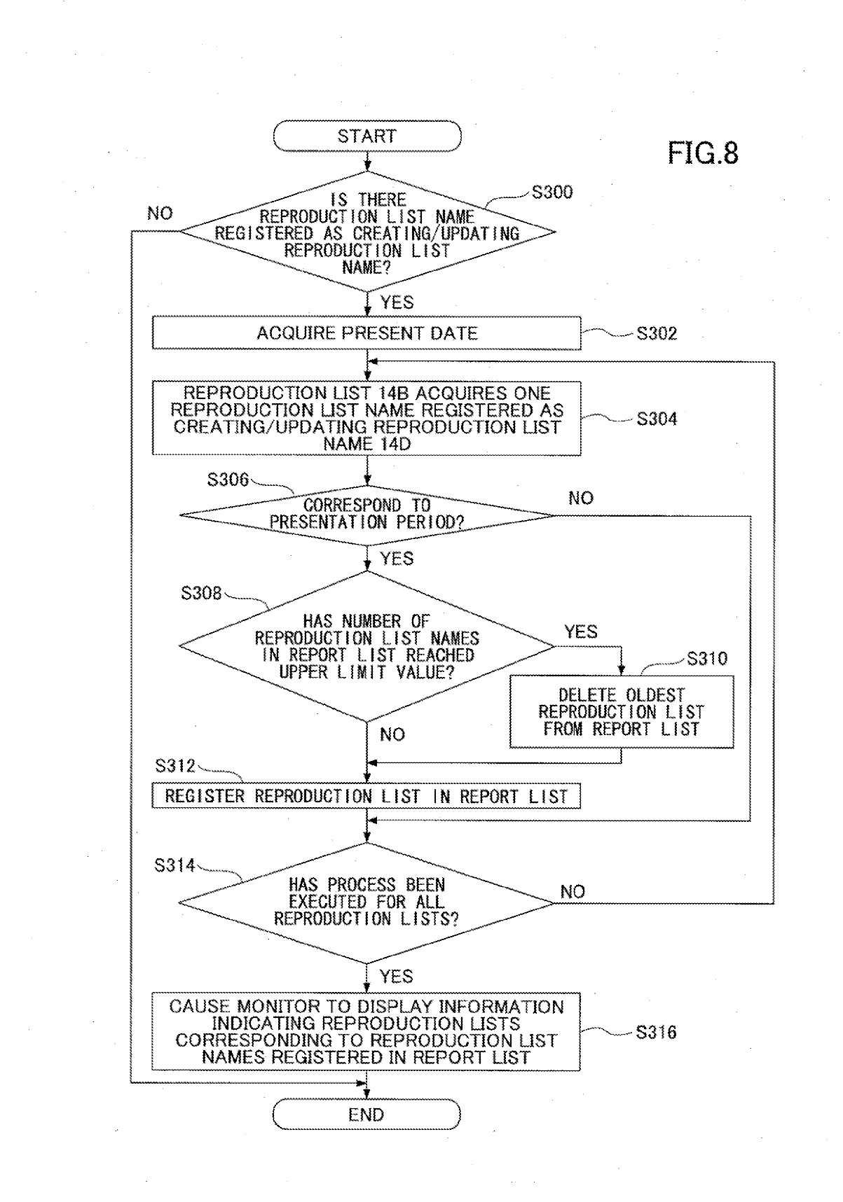

FIG. 8 is a flowchart illustrating the flow of a process executed by the report control unit 10B. For example, the present flow is executed when the contents reproducing device 1 is activated, when the OS is activated, and when the contents reproducing device 1 recovers from a standby state. For example, the flow of the present flowchart is also executed when it is detected that the reproduction list creating unit 10A has updated the creating/updating reproduction list name 14D, or when the reproduction list creating unit 10A reports that the creating/updating reproduction list name 14D is updated.

The creating/updating reproduction list name 14D determines whether there is a reproduction list name registered as the creating/updating reproduction list name 14D (step S300). When there is no reproduction list name registered as the creating/updating reproduction list name 14D, the reproduction list 14B ends the flow of the flowchart.

When there is a reproduction list name registered as the creating/updating reproduction list name 14D, the reproduction list 14B acquires the present date (step S302). For example, the process of the present step is performed by API of a system call of the operation system.

Next, the reproduction list 14B acquires one reproduction list name registered as the creating/updating reproduction list name 14D (step S304).

Next, the reproduction list 14B determines whether the present date acquired in step 5302 corresponds to the presentation period of the reproduction list name acquired in step 5304 (step S306).

When the present date corresponds to the presentation period, the reproduction list 14B determines whether the number of reproduction list names registered in the report list 14E has reached the upper limit value (for example, about ten) (step S308). When the number of reproduction list names registered in the report list 14E has reached the upper limit value, the reproduction list 14B deletes the oldest reproduction list name among the reproduction list names registered in the report list 14E (step S310). The report control unit 10B registers the reproduction list name acquired in step 5304 in the report list 14E (step S312).

When the oldest reproduction list name is deleted in step 5310, this is not particularly reported to the user. This is because it is considered that the report list is automatically created by the system and the old reproduction list name is remaining because the user is not particularly interested. Thus, to avoid inconveniences, it is not reported to the user every time a reproduction list name is deleted. By automatically deleting an old reproduction list name, the user is spared from time-consuming operations of manually deleting a reproduction list name that the user is not interested in.

Next, the report control unit 10B determines whether the process has been executed for all reproduction list names registered as creating/updating reproduction list names 14D (step S314). When the process has not been executed for all reproduction list names registered as creating/updating reproduction list names 14D, the report control unit 10B returns to step 5304 and acquires the next reproduction list name.

When the process has been executed for all reproduction list names registered as creating/updating reproduction list names 14D, the reproduction list 14B displays information indicating reproduction lists corresponding to the reproduction list names registered in the report list 14E on the monitor 40 to report this to the user (step S316). The information indicating reproduction lists is displayed in an image area such as a gadget or a pop-up, and when the user clicks (or touches) the image area with the mouse 44, the reproduction list starts being reproduced. The click or touch operation of the image area by the user is detected by the reproduction list selection receiving unit 10C, and is conveyed to the extraction process/reproduction control unit 10D.

The report list 14E is described as independent data; however, similar to the creating/updating reproduction list name 14D, the report list 14E may be realized by attaching an identifier to the image database 14A.

When the reproduction lists are reproduced in a format imitating a museum, the “information indicating reproduction lists” is preferably displayed in a format of tickets to the museum. In the following, the information indicating a reproduction list, which is in the image area for instructing to reproduce a reproduction list, is simply referred to as a “ticket”.

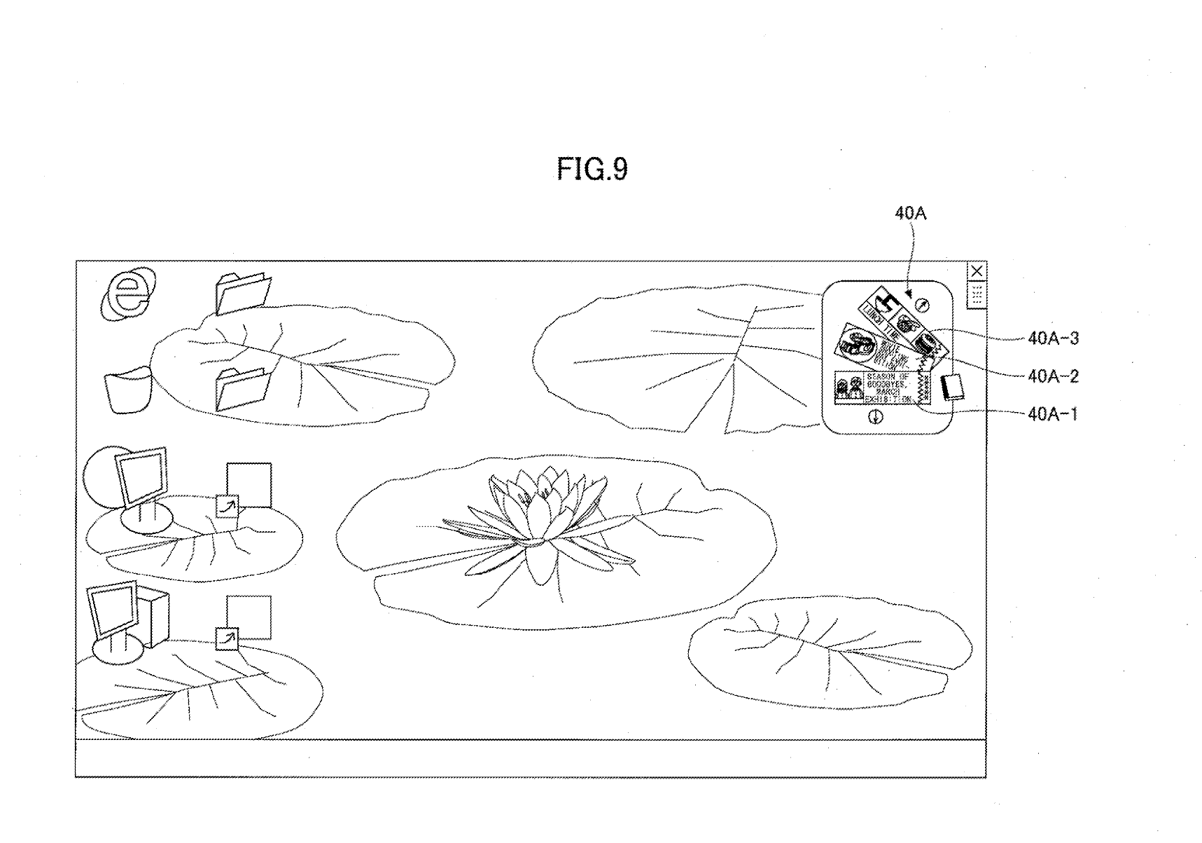

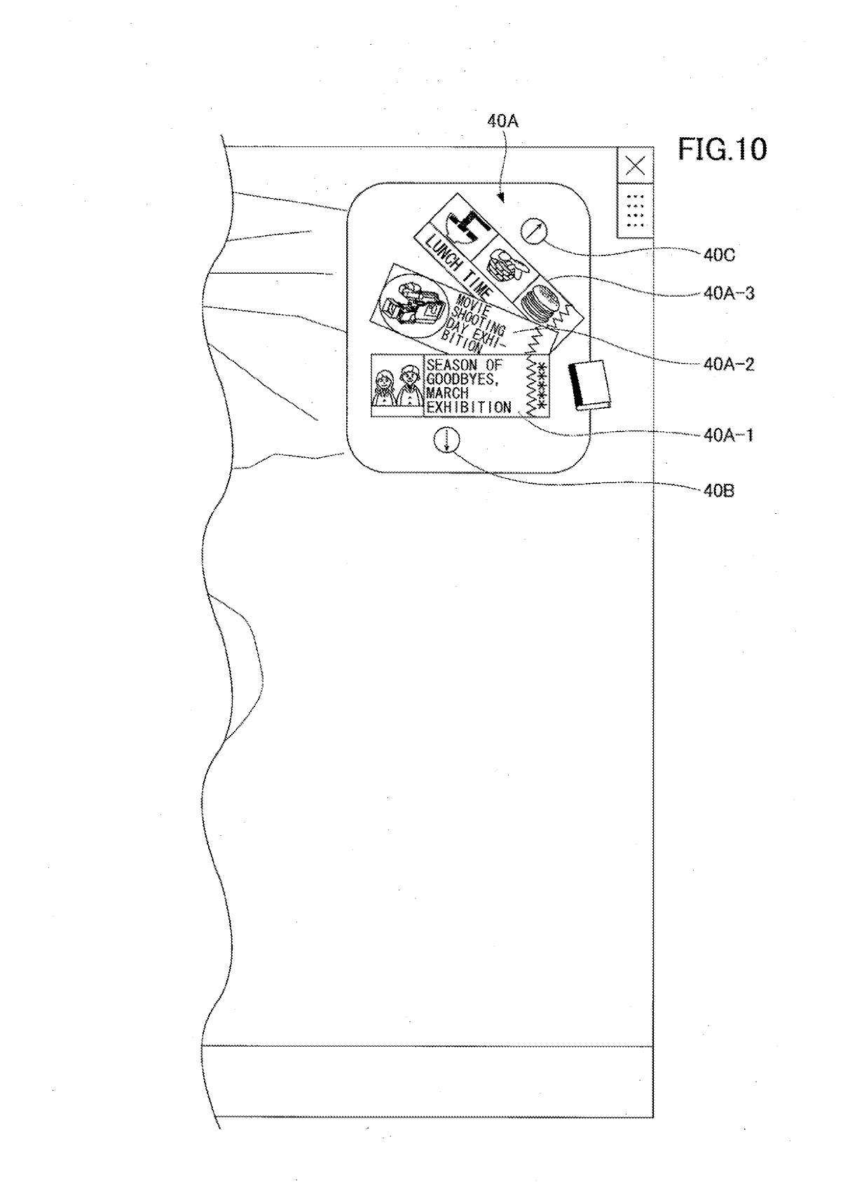

FIGS. 9 and 10 illustrate tickets 40A displayed on a desktop screen of the monitor 40. As illustrated in FIGS. 9 and 10, as the designs of the tickets 40A-1 through 40A-3, the image data selected from the reproduction list expressed by the ticket and the name of the reproduction list are displayed. For example, the image data displayed in these tickets is randomly selected from the reproduction list.

Furthermore, there are ten reproduction list names registered in the report list 14E, but the three newest tickets 40A are displayed. However, the user may click the arrow buttons 40B and 40C to sequentially display the reproduction lists in the image area.

As described above, by limiting the number of tickets that are displayed, it is possible to report to the user that there is a certain number of tickets, without deteriorating the visibility of each ticket displayed on the desktop. Furthermore, as described above, by limiting the number of reproduction list names registered in the report list 14E, it is possible to prevent the scrolling operation from becoming inconvenient for the user. The arrow buttons 40B and 40C may be controlled to pop up when the mouse 44 is brought on the gadget including the ticket 40A.

Furthermore, the newly added ticket is preferably displaying an icon saying “New” on the ticket to indicate that the ticket is new. Furthermore, when a new ticket is added, a balloon message for reporting this may be displayed from the gadget.

As illustrated in FIG. 5, by setting the extraction condition and presentation period according to the feature of each reproduction list, the reproduction list may be further adapted to the usage scene of the user.

For example, in the case of an image list including images of Golden Week, the presentation period is set from April 15 that is two weeks before Golden Week starts to May 5 when Golden Week ends, and the extraction condition is set from April 29 to May 5. According to these conditions, images photographed during Golden Week in the past are presented two weeks before Golden Week, so that the user may look back to where he traveled last year and the year before last, and scenes connecting to this year's travelling schedule may be produced. In another example, in a case of a reproduction list including autumn images, the presentation period is set from September 1 to November 30, and the extraction condition is similarly set from September 1 to November 30. By setting the presentation period and the extraction condition to be the same, images taken last fall are displayed during the autumn season, so that the user feels seasonality.

Here, in a reproduction list where the presentation period is not limited such as “early-morning” in FIG. 5, a ticket may be displayed all year round. However, for a reproduction list of this type, the reproduction list 14B may display a ticket only one day a week.

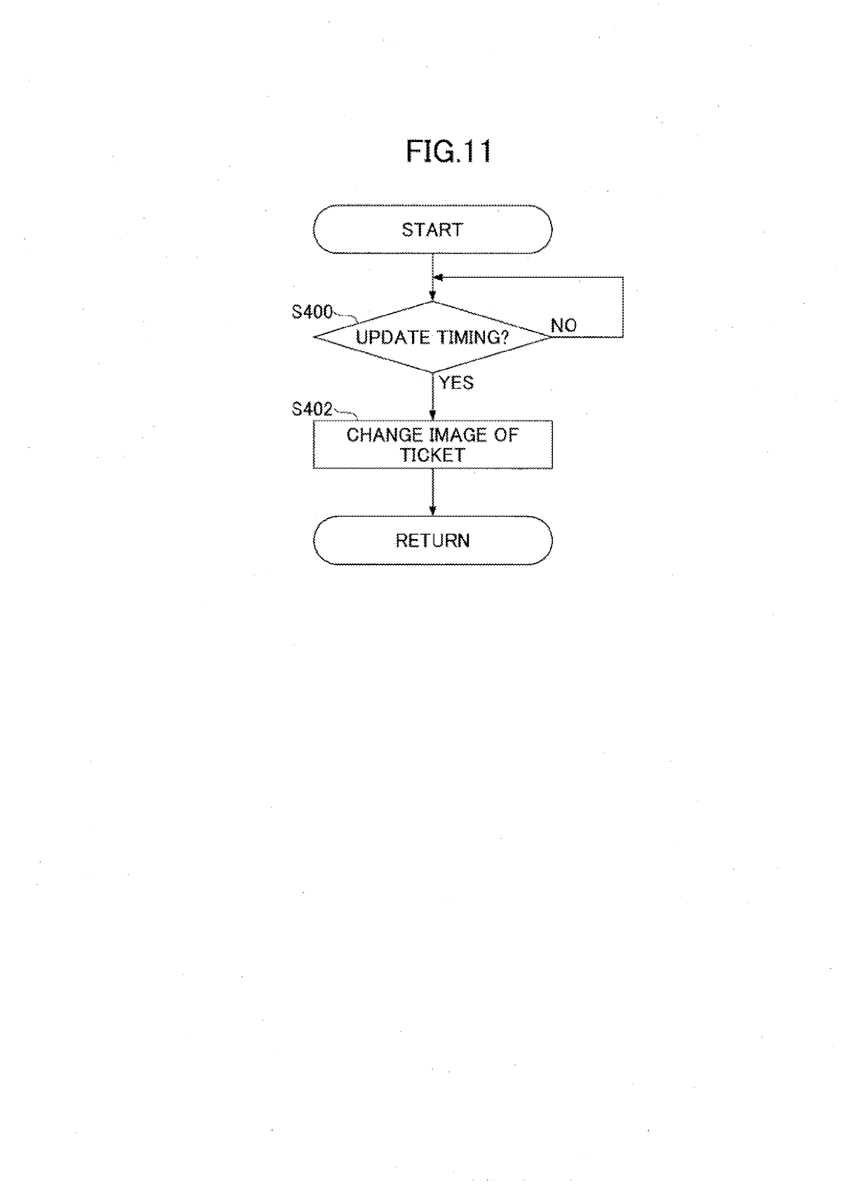

When a reproduction list that has not been reproduced is displayed by the same image for many days, the user may become tired of the image, and may not be motivated to reproduce the reproduction list. Therefore, the image of the ticket may be updated at update timings as described below. FIG. 11 is a flowchart illustrating the flow of a ticket image update process executed by the report control unit 10B.

The report control unit 10B determines whether the update timing has approached (step S400). The update timing may be arbitrarily set, such as once a day or once every few days.

When the update timing approaches, the report control unit 10B changes the image of the ticket for the reproduction list presently registered in the report list 14E (step S402).

By the above process, the image of the ticket for the reproduction list presently registered in the report list 14E is updated not only at the timing when the report list 14E is updated, but also at the timing when the date has changed. Therefore, the user may be motivated to reproduce the reproduction list.

By the above process relevant to creating and updating a reproduction list and implementing report control, tickets relevant to reproduction lists corresponding to the presentation period are displayed, among the reproduction lists that have not been reproduced. As a result, opportunities for reproducing contents (images) are actively provided to the user.

Reproduction control

When the user selects a reproduction list by clicking or touching any of the tickets, the reproduction list selection receiving unit 10C detects this, and the reproduction list corresponding to the ticket is reproduced by the reproduction list selection receiving unit 10C.

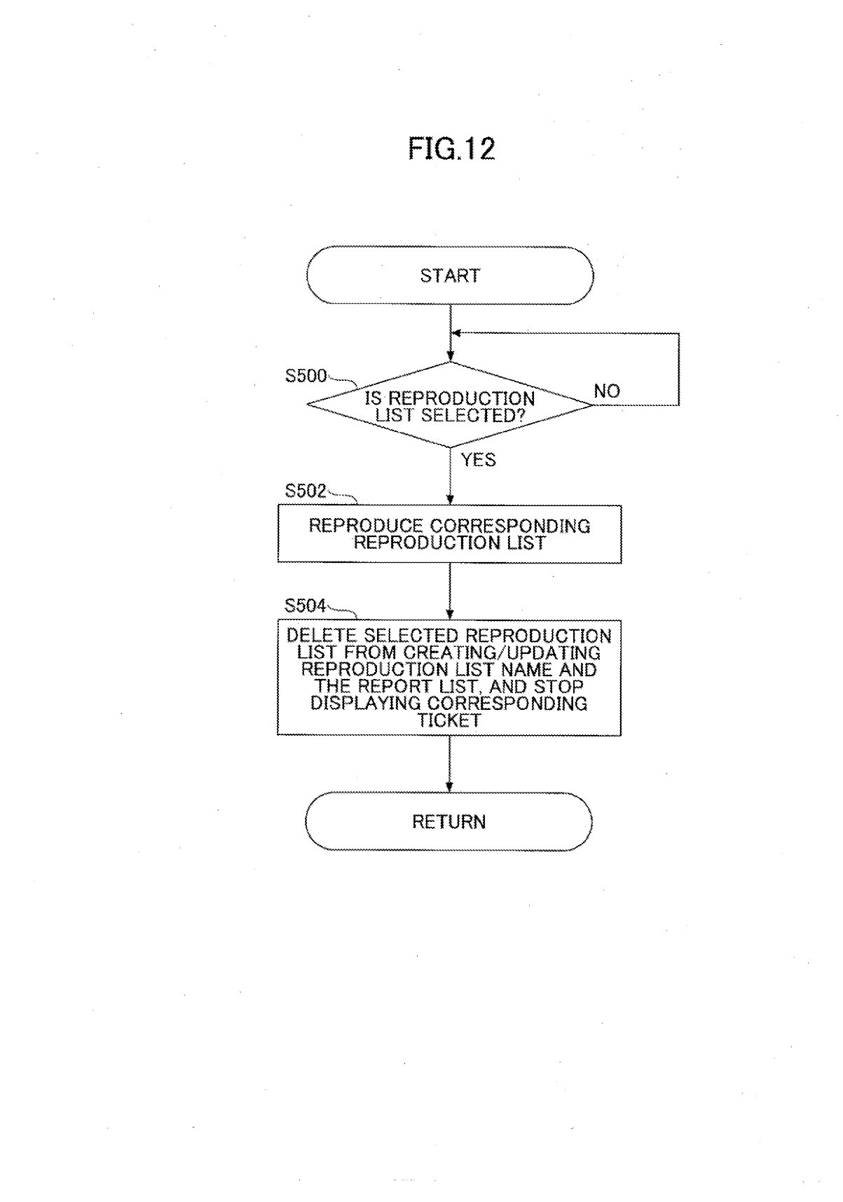

FIG. 12 is a flowchart illustrating the flow of a process executed by the reproduction list selection receiving unit 10C.

The reproduction list selection receiving unit 10C waits for a user to select a reproduction list (step S500). In this waiting state, the reproduction list selection receiving unit 10C may perform polling or wait for an interruption report from the input interface 22.

When the user selects a reproduction list, the reproduction list selection receiving unit 10C causes the extraction process/reproduction control unit 10D to reproduce the corresponding reproduction list (step S502).

Next, the reproduction list selection receiving unit 10C deletes the selected reproduction list from the creating/updating reproduction list name 14D and the report list 14E, and stops displaying the corresponding ticket (step S504). Accordingly, the ticket for the corresponding reproduction list is no longer displayed.

The extraction process/reproduction control unit 10D reproduces the reproduction list in the format of, for example, a slideshow, according to an instruction from the reproduction list selection receiving unit 10C. The extraction process/reproduction control unit 10D controls the reproduction of a slideshow by referring to the display layout information 14C.

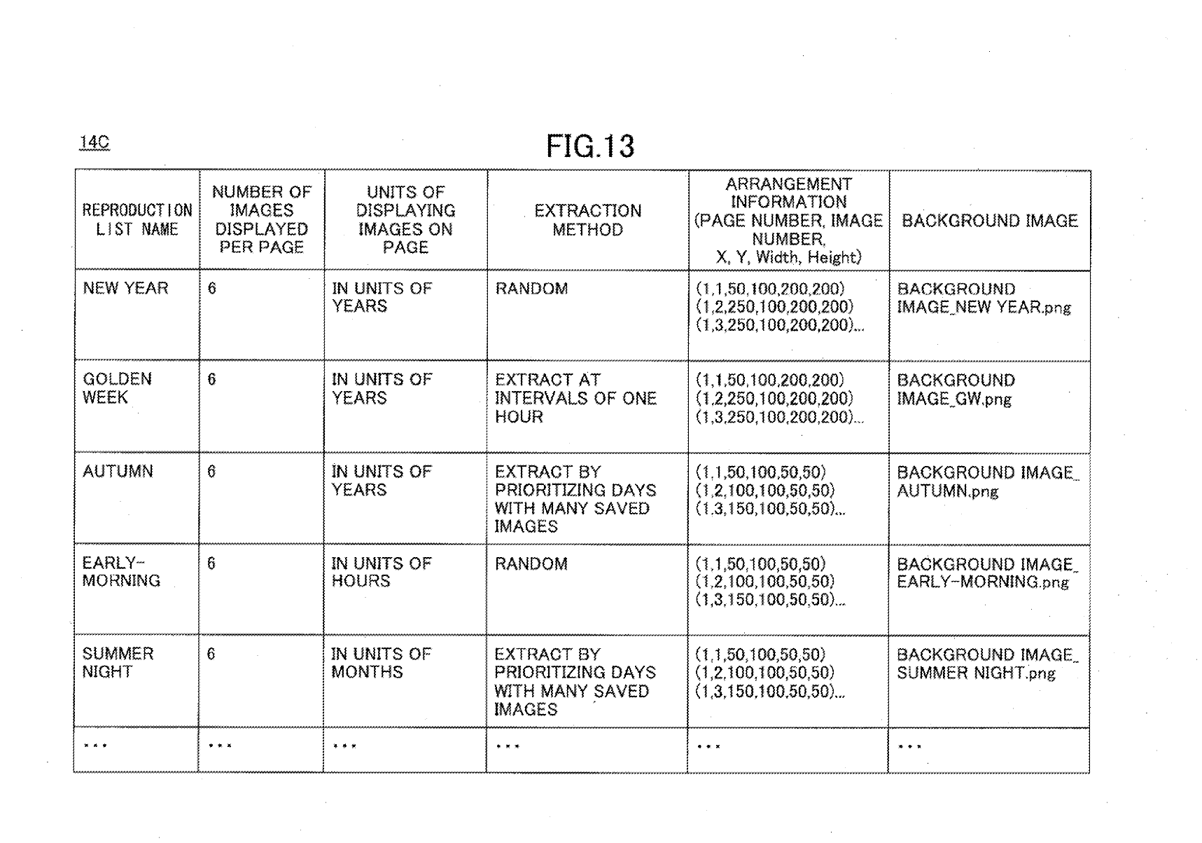

FIG. 13 illustrates an example of the display layout information 14C. The display layout information 14C describes information of a layout used when displaying each reproduction list. Furthermore, the display layout information 14C includes information relevant to a reproduction list name, the number of images per page when displaying the reproduction list, the unit of displaying images on a page (display unit), the method of extracting images, arrangement information on a page, and the background image of the page.

The slideshow display is performed by the monitor 40. Each image is in a thumbnail format, and plural images are arranged on the screen in time series. Accordingly, the user may enjoy plural images at a time, and may look back at memories when the images were taken in chronological order. Furthermore, there are plural pages, and the images extracted by the extraction process/reproduction control unit 10D are displayed according to the display layout information 14C.

For example, if the reproduction list name is “New Year”, the display unit is units of years, and therefore the extraction process/reproduction control unit 10D displays a slideshow so that images are displayed in the order of images of New Year in 2005→images of New Year in 2006→images of New Year in 2007. Accordingly, incidents that happen each year are collectively displayed, so that it is easy to look back at memories. The number of images in each slideshow is, for example, six images.

As described above, by using the display layout information 14C, it is possible to display images in units having meaning in each list.

When the reproduction list name is “New Year”, the extraction process/reproduction control unit 10D sorts the images included in the reproduction list by year, and extracts six images from each year. The extracting method is defined by the display layout information 14C.

Furthermore, when the reproduction list name is “early-morning”, the extraction process/reproduction control unit 10D sorts the images included in the reproduction list in the order of hours, and extracts six images from each hour. Similarly, when the reproduction list name is “summer night”, the extraction process/reproduction control unit 10D sorts the images included in the target image list by month, and extracts six images from each month.

Furthermore, the extraction method is described. When the reproduction list name is “New Year”, the extraction method is set to be a random method.

Meanwhile, in an event such as “Golden Week”, the number of images tends to increase, and similar contents are often continuously recorded. In this case, if images are randomly extracted, images that have been continuously taken may be continuously displayed, which is not preferable. Furthermore, when images are continuously taken, the number of images of that scene increases relatively. Therefore, if the images are randomly extracted, plural images of the continuously taken scene are apt to be selected. Thus, by extracting images taken during that period by intervals of more than a predetermined value, it is easier to look back at the incidents during the event in a time series. Accordingly, it is defined that images are to be extracted by intervals of one hour for “Golden Week”.

Furthermore, in the case of a reproduction list including “autumn images”, the extraction condition is three months which is a long period of time. Therefore, if images are extracted randomly or by equal intervals, images of days when not many images are taken may be displayed. Accordingly, when the extraction condition is a long period of time such as three months, the dates in the extraction condition period are sorted in the order of the number of images taken, and images are extracted from the days when many images have been taken. Thus, images of days when most images are taken are extracted in the extraction condition period, and therefore special days in the period are remembered in detail.

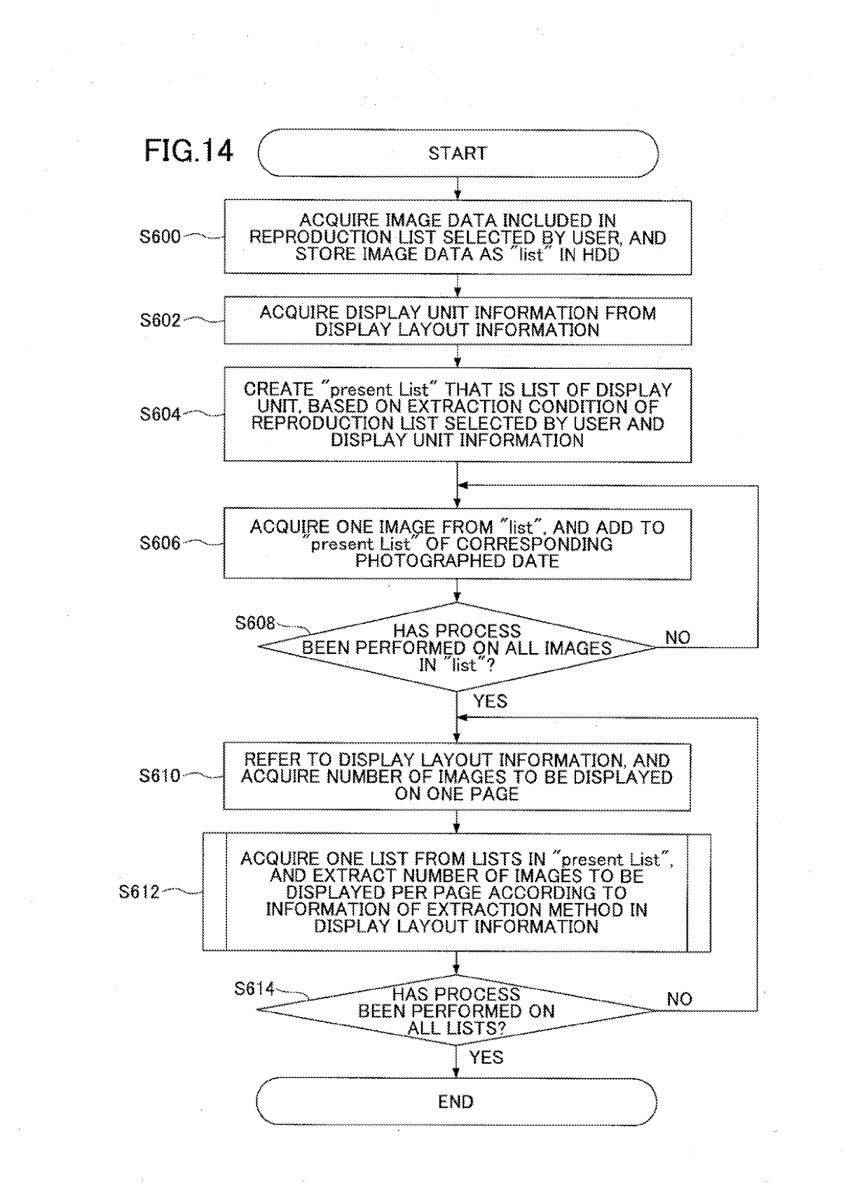

FIG. 14 is a flowchart illustrating the flow of a process executed by the extraction process/reproduction control unit 10D. The flow of the flowchart starts according to an instruction of the reproduction list selection receiving unit 10C.

The extraction process/reproduction control unit 10D acquires image data included in the reproduction list selected by the user, and stores the image data as “List” in the HDD 14 (step S600).

Next, the extraction process/reproduction control unit 10D acquires display unit information of the corresponding reproduction list from the display layout information 14C (step S602).

Next, the extraction process/reproduction control unit 10D creates “present List” that is a list of the display unit, based on the extraction condition of the reproduction list selected by the user and the display unit information (step S604).

A description is given of the creating of a “present List”. The method of creating a “present List” differs according to whether the display unit is units of years, in units of hours, or in units of months. When the reproduction list name is “New Year”, the extraction condition is “1/1-1/7”, and the display unit is “in units of years”, and therefore lists of years are created. This is done by sorting the images included in the target reproduction list in the order of the dates when the images are taken, and year lists are to be created between the oldest image and the newest image. Assuming that the oldest image is 2003 and the newest image is 2011, the year lists are “2003, 2004, 2005, . . . , 2010, 2011”. Furthermore, when the reproduction list is “Golden Week” or “autumn”, the display unit is “in units of years”, and therefore year lists are created by the same procedure as “New Year”.

Meanwhile, assuming that the reproduction list is “early-morning”, the extraction condition is “4:00:00-6:59:59”, and the display unit is “in units of hours”, and therefore lists of hours are created. In this case, the hours are specified in the extraction condition, so unlike the case of year lists, there is no particular need to identify the images included in the target image list. Accordingly, the hour lists are “four o'clock, five o'clock, six o'clock”.

When the reproduction list is “summer night”, the extraction condition is “6/1-8/31 and 17:00:00-23:59:59” and the display unit is “in units of months”, and therefore lists of months are created. In this case also, the extraction condition is specified, so there is no particular need to identify the images included in the target image list. Accordingly, the month lists are “June, July, August”.

Next, the extraction process/reproduction control unit 10D acquires one image from “list”, and adds the acquired image to the “present list” of the corresponding date of the photograph (photographed date) (step S606). For example, when the display unit of lists is year lists, the extraction process/reproduction control unit 10D assigns the images to the lists based on the year when the image was taken. Furthermore, when the display unit of lists is hour lists, the extraction process/reproduction control unit 10D assigns the images to the lists based on the hour when the image was taken. Furthermore, when the display unit of lists is month lists, the extraction process/reproduction control unit 10D assigns the images to the lists based on the month when the image was taken.

Next, the extraction process/reproduction control unit 10D determines whether the process has been performed on all images in the “list” (step S608). When the process has not been performed on all images in the “list”, the extraction process/reproduction control unit 10D returns to step 5606, and acquires the next image in “list”.

When the process has been performed on all images in the “list”, the extraction process/reproduction control unit 10D refers to the display layout information 14C, and acquires the number of images to be displayed on one page (step S610).

Next, the extraction process/reproduction control unit 10D acquires a list from the lists in “present list”, and extracts a number of images to be displayed per page according to the information of the extraction method in the display layout information 14C (step S612). For example, in the case of year lists, the lists correspond to the lists of 2003, 2004, 2005, . . . , 2010, 2011.

Next, the extraction process/reproduction control unit 10D determines whether the process has been performed on all lists (step S614). When the process has not been performed on all lists, the extraction process/reproduction control unit 10D returns to step 5610 and acquires the next list and performs the process.

When the process has been performed on all lists, the extraction process/reproduction control unit 10D ends the process of the present flowchart.

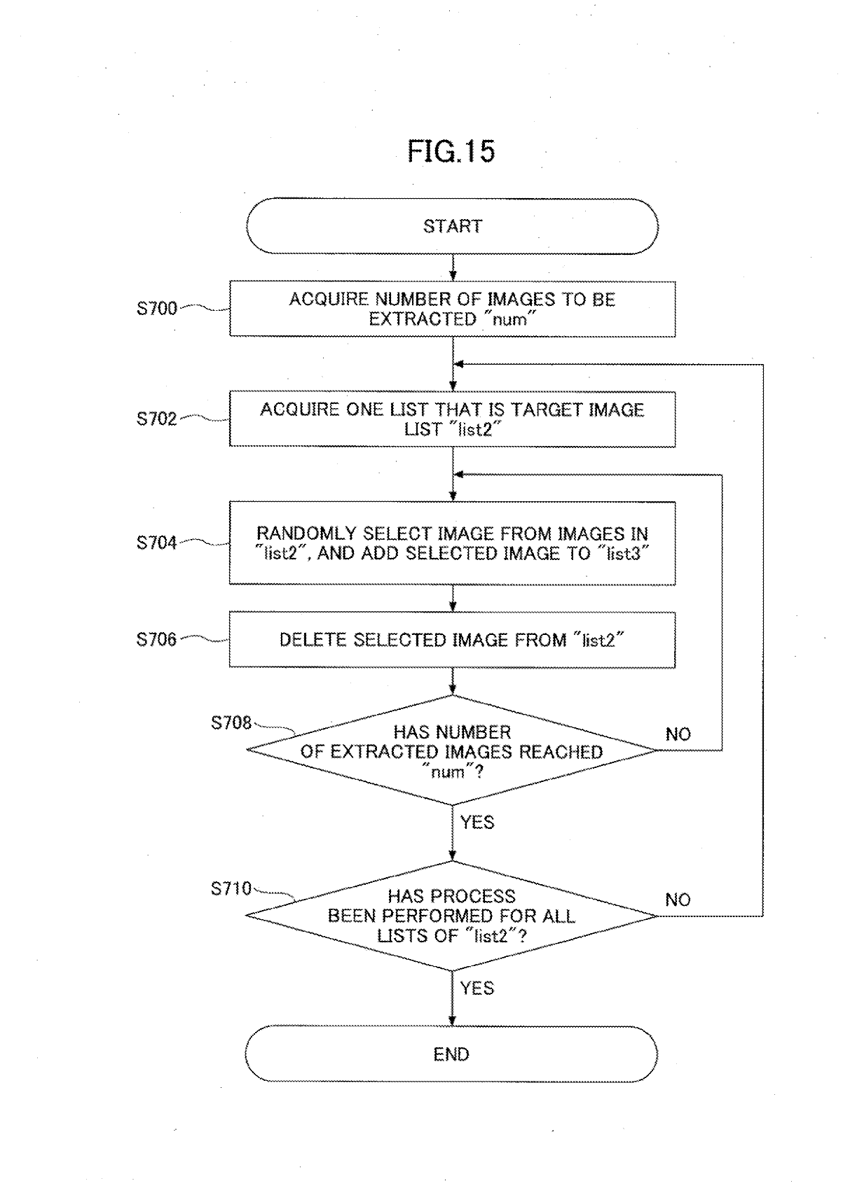

In the following, a description is given of a process according to extraction methods. FIG. 15 is a flowchart of a process executed by the extraction process/reproduction control unit 10D when the method of extracting images is “random”. For example, when the list is “New Year” and “early-morning”, the extraction method is “random”, and therefore images in the lists in the respective display units are randomly selected. In the case of “New Year”, the extraction process/reproduction control unit 10D randomly selects six images, which is the number of images to be displayed for each year of “2003, 2004, 2005, ..., 2010, 2011”. Furthermore, in the case of “early-morning”, the extraction process/reproduction control unit 10D randomly selects six images, which is the number of images to be displayed for each hour of “four o'clock, five o'clock, six o'clock”.

The extraction process/reproduction control unit 10D acquires the number of images to be extracted “num” (step S700).

Next, the extraction process/reproduction control unit 10D acquires one list that is a target image list “list2” (step S702). The target image list “list2” corresponds to lists in the “present List” in the flowchart of FIG. 14.

Next, the extraction process/reproduction control unit 10D randomly selects an image from the images in “list2”, and adds the selected image to “list3” (step S704), and deletes the selected image from “list2” (step S706).

Next, the extraction process/reproduction control unit 10D determines whether the number of extracted images has reached “num” (step S708). When the number of extracted images has not reached “num”, the extraction process/reproduction control unit 10D returns to step 5704 and extracts an image.

When the extracted number of images has reached “num”, the extraction process/reproduction control unit 10D determines whether the process has been performed for all of the lists of “list2” (step S710). When the process has not been performed for all of the lists of “list2”, the extraction process/reproduction control unit 10D returns to step 5702 and acquires the next “list2”.

When the process has been performed for all of the lists of “list2”, the extraction process/reproduction control unit 10D ends the process of the present flowchart.

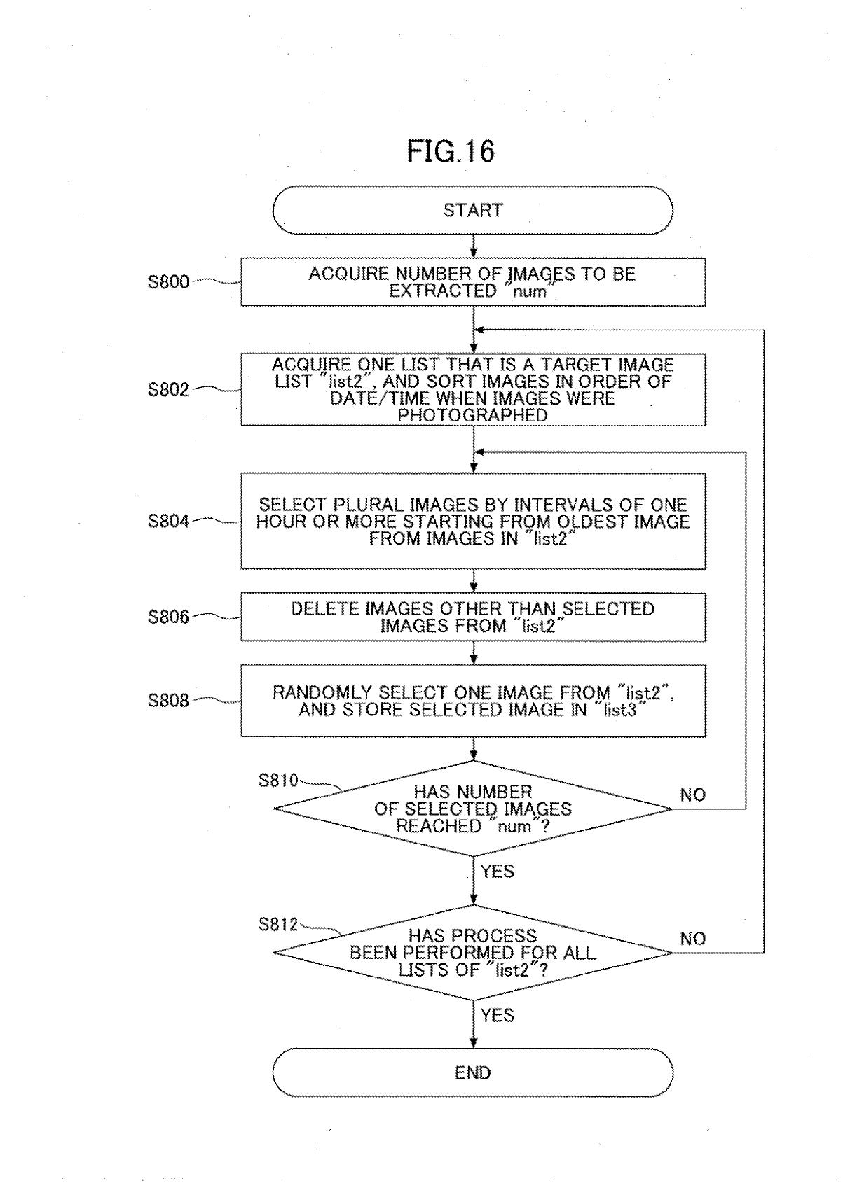

FIG. 16 is a flowchart of a process executed by the extraction process/reproduction control unit 10D when the method of extracting images is “extract by predetermined intervals”. For example, in the case of a list of “Golden Week”, the extraction method is “extract by predetermined intervals”, and therefore the images in the lists in display units are selected by intervals of one hour or more.

First, the extraction process/reproduction control unit 10D acquires the number of images to be extracted “num” (step S800).

Next, the extraction process/reproduction control unit 10D acquires one list that is a target image list “list2”, and sorts the images in the order of the date/time when the images were photographed (step S802).

Next, the extraction process/reproduction control unit 10D selects plural images by intervals of one hour or more starting from the oldest image, from the images in the “list2” (step S804), and deletes the images other than the images that have been selected from “list2” (step S806).

In step 5804, the images in the “list2” are sorted in the order of the photographed date/time, and therefore the photographed dates/times are checked starting from the first image. The images having intervals of one hour or more are left to remain in the “list2”, and images that come before one hour or more are deleted from the “list2”. Then, based on the date/time of the remaining images, images having intervals of one hour or more are checked again, and images are deleted from or left to remain in the “list2”. When all images are processed, all of the images in the “list2” will have intervals of one hour or more in terms of the date/time.

Next, the extraction process/reproduction control unit 10D randomly selects one image from the “list2”, and stores the selected image in the “list3” (step S808).

Next, the extraction process/reproduction control unit 10D determines whether the number of selected images has reached “num” (step S810). When the number of selected images has not reached “num”, the extraction process/reproduction control unit 10D returns to step 5804 and extracts an image.

When the number of selected images has reached “num”, the extraction process/reproduction control unit 10D determines whether the process has been performed for all lists of “list2” (step S812). When the process has not been performed for all lists of “list2”, the extraction process/reproduction control unit 10D returns to step 5802 and acquires the next “list2”.

When the process has been performed for all lists of “list2”, the extraction process/reproduction control unit 10D ends the process of the present flowchart.

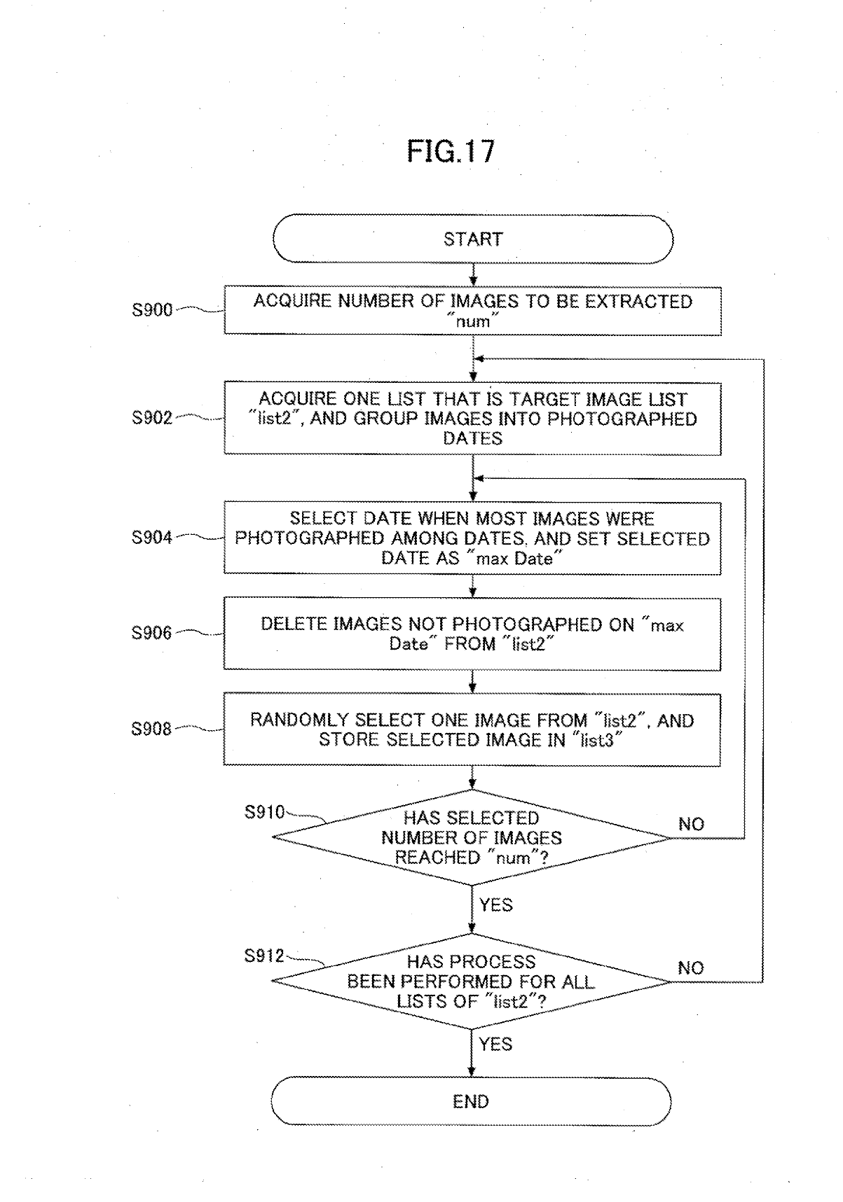

FIG. 17 is a flowchart of a process executed by the extraction process/reproduction control unit 10D when the method of extracting images is “extract by prioritizing days with many saved images”. For example, for lists of “autumn” and “summer night”, the extraction method is “extract by prioritizing days with many saved images”, and therefore the images are selected so that the images in the lists in display units are of days when many images were taken.

First, the extraction process/reproduction control unit 10D acquires the number of images to be extracted “num” (step S900).

Next, the extraction process/reproduction control unit 10D acquires one list that is a target image list “list2”, and groups the images based on the photographed dates (step S902).

Next, the extraction process/reproduction control unit 10D selects the date when most images were photographed among the dates, and sets the selected date as “max Date” (step S904). In this step, the extraction process/reproduction control unit 10D acquires images starting from the top image of the “list2”, refers to the information of the photographed date, and increments the count of the corresponding photographed date by one. When the extraction process/reproduction control unit 10D processes all of the images in the “list2”, the count for each of the photographed days are determined. Therefore, the day having the highest count is identified, and the identified photographed date is set as “max Date”.

Next, the extraction process/reproduction control unit 10D deletes images that were not photographed on the “max Date” from the “list2” (step S906).

Next, the extraction process/reproduction control unit 10D randomly selects one image from the “list2”, stores the selected image in the “list3”, and deletes the selected image from the “list2” (step S908).

Next, the extraction process/reproduction control unit 10D determines whether the selected number of images has reached “num” (step S910). When the selected number of images has not reached “num”, the extraction process/reproduction control unit 10D returns to step 5904 and extracts an image.

When the selected number of images has reached “num”, the extraction process/reproduction control unit 10D determines whether the process has been performed for all lists of “list2” (step S912). When the process has not been performed for all lists of “list2”, the extraction process/reproduction control unit 10D returns to step 5902 and acquires the next “list2”.

When the process has been performed for all lists of “list2”, the extraction process/reproduction control unit 10D ends the process of the present flowchart.

When extraction of images is completed by the process of FIG. 14 and any one of the processes of FIGS. 15 through 17, the extraction process/reproduction control unit 10D performs a process of displaying the extracted images.

The extraction process/reproduction control unit 10D acquires the images of the “list3”, sorts the images in the order of the photographed date, and arranges the images according to display layout information. The images are arranged according to arrangement information. The extraction process/reproduction control unit 10D assigns image numbers in the order in which the images are sorted, and arranges the images on the pages and positions displaying the image number.

Overview

According to the above-described contents reproducing device according to the present embodiment, the extraction process/reproduction control unit 10D displays tickets relevant to reproduction lists which have not been reproduced on the monitor 40, and therefore opportunities of reproducing contents are actively provided to the user.

Furthermore, according to the contents reproducing device according to the present embodiment, tickets of reproduction lists which have not been reproduced and which correspond to a presentation period are displayed on the monitor 40, and therefore contents with seasonality are provided to the user.

Furthermore, according to the contents reproducing device according to the present embodiment, the reproduction lists that have not been reproduced are reported to the user in the format of tickets, and therefore the user is motivated to reproduce the contents.

Furthermore, according to the contents reproducing device according to the present embodiment, there is an upper limit to the number of displayed tickets and the number of reproduction lists that have not been reproduced, and therefore the inconvenience when the user selects reproduction lists is reduced.

Furthermore, according to the contents reproducing device according to the present embodiment, when the extraction condition is a temporal condition, the slideshow is displayed in units that are in a narrower range than the temporal condition, and therefore the images are provided in units having meaning.

Furthermore, according to the contents reproducing device according to the present embodiment, images corresponding to the display unit are further extracted and displayed on each page of the slideshow, and therefore an appropriate number of images are displayed at once.

Furthermore, according to the contents reproducing device according to the present embodiment, when extracting the images as described above, the images are extracted according to an extraction rule corresponding to the extraction condition, and therefore the images displayed at once are more easily understood by the user compared to a case of extracting images without conditions.

As described above, according to the contents reproducing device according to the present embodiment, a new type of enjoyment in reproducing content is provided.

According to an aspect of the present invention, it is possible to actively provide opportunities of reproducing content for the user.

The contents reproducing device is not limited to the specific embodiments described herein, and variations and modifications may be made without departing from the scope of the present invention.

For example, contents reproduced by the contents reproducing device are photographed images in the above description, but the contents may be graphic images, music, etc.

Furthermore, when the number of reproduction list names registered in the report list 14E reaches an upper limit value, the reproduction list 14B deletes the oldest reproduction list name from the reproduction list names registered in the report list 14E; however, all of the reproduction list names may be reported without specifying an upper limit value.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A contents reproducing device connected to a reproduction unit that reproduces contents data, the contents reproducing device comprising:
a storage unit configured to store the contents data;
an extraction unit configured to extract condition-satisfying-contents data that satisfies a predetermined extraction condition from the contents data stored in the storage unit, and store information identifying the extracted condition-satisfying-contents data in the storage unit;
a reproduction control unit configured to cause the reproduction unit to reproduce the contents data in the storage unit in units of the condition-satisfying-contents data; and
a report control unit configured to determine whether non-reproduced condition-satisfying-contents data that has not been reproduced by the reproduction control unit is present, and to cause a report unit to make a report relevant to the non-reproduced condition-satisfying-contents data when the non-reproduced condition-satisfying-contents data is present.

2. The contents reproducing device according to claim 1, wherein
the report control unit is configured to determine whether non-reproduced condition-satisfying-contents data corresponding to a presentation period indicated by the predetermined extraction condition is present in the non-reproduced condition-satisfying-contents data, and cause the report unit to make a report relevant to the non-reproduced condition-satisfying-contents data corresponding to the presentation period when the non-reproduced condition-satisfying-contents data corresponding to the presentation period is present.

3. The contents reproducing device according to claim 1, wherein
the report unit is a display unit, and the report control unit is configured to cause the display unit to display an image area for starting to reproduce the non-reproduced condition-satisfying-contents data, when the non-reproduced condition-satisfying-contents data is present.

4. The contents reproducing device according to claim 3, wherein
the report control unit is configured to set an upper limit to a number of items of the non-reproduced condition-satisfying-contents data,
cause the display unit to display the image area relevant to at least one item of the non-reproduced condition-satisfying-contents data within the upper limit, and
enable a user to view all items of the non-reproduced condition-satisfying-contents data within the upper limit by a scroll operation.

5. The contents reproducing device according to claim 1, wherein
the contents data is image data that has been photographed, and
the predetermined extraction condition is relevant to a time when the image data is photographed.

6. The contents reproducing device according to claim 5, wherein
the reproduction unit is a display unit, and
the reproduction control unit is configured to cause the display unit to display the condition-satisfying-contents data in a format of a slideshow, and cause the display unit to display, on each page of the slideshow, images extracted by a condition relevant to a narrower timeframe than the predetermined extraction condition.

7. The contents reproducing device according to claim 6, wherein
the condition relevant to the narrower timeframe than the predetermined extraction condition is set such that images photographed at close times are displayed on a same page.

8. The contents reproducing device according to claim 6, wherein
the report control unit is configured to cause the display unit to display, on each page of the slideshow, images extracted according to an extraction rule corresponding to the predetermined extraction condition, from the images extracted by the condition relevant to the narrower timeframe than the predetermined extraction condition.

9. A non-transitory computer-readable recording medium storing a contents reproduction program that causes a computer, which is connected to a reproduction unit that reproduces contents data, to execute a method comprising:
extracting condition-satisfying-contents data that satisfies a predetermined extraction condition from the contents data stored in a storage unit, and storing information identifying the extracted condition-satisfying-contents data in the storage unit;
causing the reproduction unit to reproduce the contents data in the storage unit in units of the condition-satisfying-contents data; and
determining whether non-reproduced condition-satisfying-contents data that has not been reproduced at the causing is present, and causing a report unit to make a report relevant to the non-reproduced condition-satisfying-contents data when the non-reproduced condition-satisfying-contents data is present.

10. The non-transitory computer-readable recording medium according to claim 9, wherein
the determining includes determining whether non-reproduced condition-satisfying-contents data corresponding to a presentation period indicated by the predetermined extraction condition is present in the non-reproduced condition-satisfying-contents data, and causing the report unit to make a report relevant to the non-reproduced condition-satisfying-contents data corresponding to the presentation period when the non-reproduced condition-satisfying-contents data corresponding to the presentation period is present.

11. The non-transitory computer-readable recording medium according to claim 9, wherein
the report unit is a display unit, and
the determining includes causing the display unit to display an image area for starting to reproduce the non-reproduced condition-satisfying-contents data, when the non-reproduced condition-satisfying-contents data is present.

12. The non-transitory computer-readable recording medium according to claim 11, wherein
the determining includes setting an upper limit to a number of items of the non-reproduced condition-satisfying-contents data,
causing the display unit to display the image area relevant to at least one item of the non-reproduced condition-satisfying-contents data within the upper limit, and
enabling a user to view all items of the non-reproduced condition-satisfying-contents data within the upper limit by a scroll operation.

13. The non-transitory computer-readable recording medium according to claim 9, wherein
the contents data is image data that has been photographed, and
the predetermined extraction condition is relevant to a time when the image data is photographed.

14. The non-transitory computer-readable recording medium according to claim 13, wherein
the reproduction unit is a display unit, and
the determining includes causing the display unit to display the condition-satisfying-contents data in a format of a slideshow, and causing the display unit to display, on each page of the slideshow, images extracted by a condition relevant to a narrower timeframe than the predetermined extraction condition.

15. The non-transitory computer-readable recording medium according to claim 14, wherein
the condition relevant to the narrower timeframe than the predetermined extraction condition is set such that images photographed at close times are displayed on a same page.

16. The non-transitory computer-readable recording medium according to claim 14, wherein
the determining includes causing the display unit to display, on each page of the slideshow, images extracted according to an extraction rule corresponding to the predetermined extraction condition, from the images extracted by the condition relevant to the narrower timeframe than the predetermined extraction condition.

17. A method for reproducing contents performed by a computer which is connected to a reproduction unit that reproduces contents data, the method comprising:
extracting condition-satisfying-contents data that satisfies a predetermined extraction condition from the contents data stored in a storage unit, and storing information identifying the extracted condition-satisfying-contents data in the storage unit;
causing the reproduction unit to reproduce the contents data in the storage unit in units of the condition-satisfying-contents data; and
determining whether non-reproduced condition-satisfying-contents data that has not been reproduced at the causing is present, and causing a report unit to make a report relevant to the non-reproduced condition-satisfying-contents data when the non-reproduced condition-satisfying-contents data is present.
